(19) United States
(12) Patent Application Publication
(10) Pub. No.: US 2007/0242284 A1
(43) Pub. Date: Oct. 18, 2007

(54) Photo Album Printing System and Method

(75) Inventors: Balten Willem Schalkwijk, Rotterdam (NL); Andy Frank Kalbvleesch, Rotterdam (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Albumservice V.O.F., Amsterdam (NL)

(21) Appl. No.: 10/583,704

(22) PCT Filed: Dec. 17, 2004
(86) PCT No.: PCT/NL04/00881

§ 371 Date: Apr. 18, 2007

(30) Foreign Application Priority Data
Dec. 17, 2003 (NL) PCT/NL03/00900

(51) Int. Cl. H04N 1/00; G06F 3/12

(52) U.S. Cl. 358/1.6; 358/434

(57) ABSTRACT

A photo album is edited and printed distributed over a client server system. A server system stores low quality and high quality digital representations of photographs. The server system sends low quality digital representations to a client computer remote from the server system in association with respective identifiers of the photographs. A user edits an electronic representation of pages of the photo album at the client computer, using an interactive display with the low quality digital representations of interactively selected photographs. After editing the client computer sends an editing result to the server system, including identifiers of the selected photographs. The server system retrieves an prints the stored high quality digital representation of the selected photographs identified by the identifiers. The user also selects positions of the photographs on pages, preferably using positions from selectable templates. The client computer may also perform user selected transformations of the photographs, transformation commands being sent to the server system to execute corresponding transformations on the high quality representations before printing.

The invention relates to the production of photo albums and to systems, methods and software for printing of photo albums.

With the advent of digital photography digital photoprinting has become a significant industry. In principle anyone with a computer and a color printer can print digital photographs, but in practice many consumers send their digital photographs to a printing service company via the Internet. The printing service company prints the photographs on paper and delivers the paper photograph to the consumer. Of course, this service is not limited to photographs directly obtained by a camera. The printing service company will print any electronic document, provided that it is in a suitable electronic format.

A photo album is a collection of printed pages that contain photographs arranged in some desired manner. It is known to produce a photo album by electronic document editing followed by printing. Editing is used to place electronic photographs at selected positions on pages of an electronic document that is later used to control printing. Printing may be performed locally, or through the intervention of a printing service company.

The conventional implementation of an editing system for preparing the electronic document that represents the photoalbum is a PC programmed with a suitable editing program. The PC has a disk on which a number of digital photographs is stored and a user enters commands into the PC to place selected the photographs at selected positions in the photo album. In response the PC prepares the electronic document, including photographs from the disk. Pages of the resulting document can be displayed on the screen of the PC and printed locally or through the intervention of a printing service company.

Another implementation is based on the client-server model. In this implementation a server computer is provided, with a memory in which the photographs are stored and the server computer runs an editing program to compose the photo album. The server computer is typically run by a printing service company. A client computer, typically a PC coupled to the server computer via the Internet, is used to send editing commands to the server computer and the server computer sends back information representing a resulting page of the photo album for display on the client computer. Later, other users can view the photo album by accessing the server computer, and the album can be printed on paper and delivered to the consumer when the consumer sends an appropriate order to the printing service company.

It has been found that consumers have a desire to include no only their own photographs but also other, professionally made photographs in their photo albums. Thus, for example, professionally made photographs of tourist sights or special events may be included. Typically a fee is due to the copyright owners of such photographs, and consumers are licensed to use such photographs only for limited purposes, eg. for a single printed copy of the photo album. The client server model supports such an exploitation, because it makes it possible to retain high quality digital representations of the copyrighted photographs exclusively at the server. For display at the client computer a low quality (resolution) digital copy of the copyrighted may be used. The high quality version of the copyrighted photograph is released on the printed paper of the photo album only and not in digital form.

Nevertheless, this client server implementation also has technical disadvantages. In particular it involves a high computational load on the server computer and it requires a high communication bandwidth to update the display of editing results at the client computer.

Among others, it is an object of the invention to provide for a system for printing photo albums wherein high quality photographs can be included in a printed photoalbum without releasing high quality digital representations of the photographs to arbitrary users and with a small computational load on a server and small bandwidth use.

The method according to the invention is set forth in claim 1. According to the invention, editing of the photo album is performed locally at the client computer. On demand from a user low quality a digital representation of a photograph in a server system is transmitted from the server to the client computer and associated with an identifier. The user views editing results on the client computer and sends back an editing result, which specifies the layout and content of the photo album using the identifiers, to the server system, which subsequently controls printing of the photo album using the high quality digital representation of the photograph associated with the identifier. Thus, the server system does not need to support editing, nor does it have to transmit successive editing results for interactive display on the client computer. On the other hand, the client does not receive high quality representations of photographs in digital form, which protects copyright.

In an embodiment the user is able to select the position of the photographs on the pages. Preferably, a plurality of templates is provided which each define a plurality of positions where photographs may be printed (templates with a single position may also be provided). This permits the user to define the positions by selecting a template. This has the advantage that accurate control over the printing result can be ensured, irrespective of how the pages are displayed at the client computer.

In another embodiment the user is able to select commands to transform the photographs before printing. The transformed photographs are shown on the client computer and the commands are transmitted to the server computer for application to the high quality representations before printing. This makes it possible to adapt the photographs without releasing the high quality representations.

These and other objects and advantageous aspects of the invention will be described using the following figures

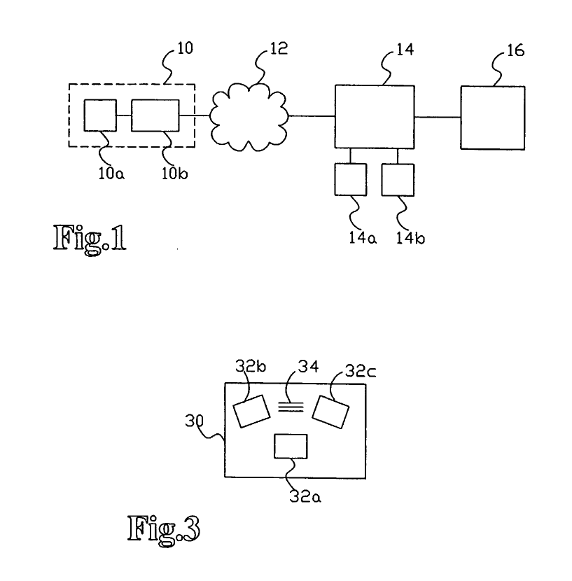

FIG. 1 shows a photo album editing system

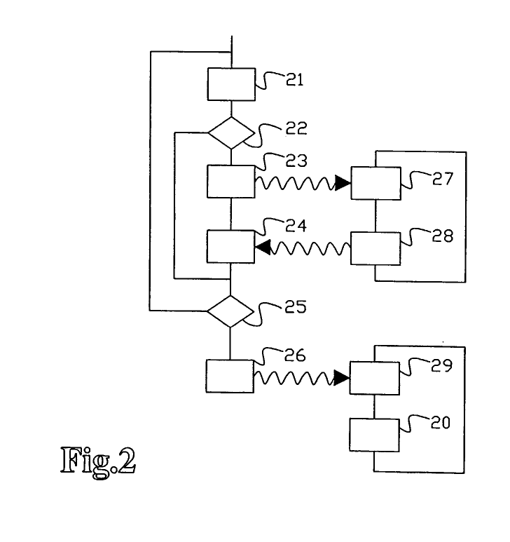

FIG. 2 illustrates flow chart of operation of a printing system

FIG. 3 illustrates a layout of a photo album

FIG. 1 shows a photo album editing system comprising a client computer 10, a communication network 12 such as the Internet, a server computer 14, with storage devices 14a, 14b and a photoprinter 16. Server computer 14 is coupled to client computer 10 via network 12 and to photoprinter 16. Client computer 10 contains a display screen 10a and processing and storage unit 10b.

In operation the editing system permits a user at client computer 10 to create and/or edit a photo album by physically entering commands into client computer 10, and subsequently to print the photo album remotely under control of server computer 14, for a fee. Server system stores publicly available photographs and preferably also sets of privately available photographs for respective subscribers. A user selects from the stored photographs for use in a photoalbum and the arrangement of selected photographs in the photoalbum. Preferably, the system provides for a log-in procedure by which respective subscribers can get access selectively to respective collections of private photographs stored on storage device 14b. Preferably, the system also provides for a procedure by which arbitrary persons can become subscribers. Preferably, the system also provides for a payment system, by which subscribers can commit payments to the operator of the server system.

Creation of a new photo album preferably starts with the display of an interface page on client computer 10, showing a number of available layout templates and a number of available sets of photographs. Each template defines a possible layout of a page of the photo-album and a plurality of positions for photographs on the page. The user enters a selection of a template, a plurality of photographs and the respective positions from the template at which the photographs have to be included in the photoalbum. Client computer 10 displays the resulting pages to the user.

FIG. 2 illustrates an example of operation of the editing system. In a first step 21 client computer 10 displays a current edit result on display screen 10a and receives editing commands from a user, e.g. via a keyboard or mouse (not shown). The commands may include commands for selecting a photograph, for entering a text for display on a page or for selecting a photograph size, a window from a photograph and/or orientation etc.

FIG. 3 shows an example of a typical photo album page 30 according to a template, as displayed by client computer 10. The page 30 contains photographs 32a-c selected by the user of client computer 10 and text 34 entered by the user at positions on the page selected by the user.

In a second step 22 client computer determines if a command requires fetching a photograph from server computer 14 for display on client computer 10. If a photograph has to be fetched client computer 10 executes a third step 23, sending a request for the photograph to server computer 14. In a fourth step 24 client computer 10 receives data representing a low quality digital version of the photograph and an identifier of the photograph. In a fifth step 25 client computer determines whether a printing command has been entered. If not client computer continues from first step 21. As a result of first step 21 client computer causes the photograph to be displayed as part of the photo album page 30 in an intermediated edit result, using the low quality digital version.

If printing is required client computer 10 executes a sixth step 26, sending an editing result with a printing command to server computer 14. The editing results contains one or more of the identifiers of photographs that the user has selected for display in the photo album, plus optionally information identifying the selected templates for different pages, information specifying the locations in the template where these photographs must be printed and/or the size, the orientation of the selected photographs, or a window selection within photographs, as well as optional text that must be printed on the pages.

Server computer 14 executes counterpart of the steps executed by client computer. Server computer 14 executes reception processes 27, 29 monitoring reception of requests for photographs from client computer 10 from third step 23 and printing commands from sixth step 26. In response to the request transmitted by client computer 10 in third step 23, server computer 14 executes a transmission step 28, fetching a low quality digital representation of a photograph from first storage device 14a and transmitting this low quality digital representation, as well as an identifier of the photograph to client computer 10.

In response to the printing command transmitted in sixth step 26 server computer 14 receives the editing result, extracts identifiers that have been placed in the editing result as a result of editing, and retrieves high quality versions of the photographs identified by these identifiers from first storage device 14a. Server computer 14 next commands photoprinter 16 to print the pages of the photoalbum according to the editing result and the selected templates, using the high quality version of the identified photographs to control printing of the photographs.

The high an low quality versions of a photograph typically represent the same photograph at a relatively higher and lower resolution respectively, and/or with relatively higher and lower color quantization steps etc.

In addition server computer 14, as a result of the printing command, may update an account record in a memory of server computer 14 according to copyright royalty information associated with the identifier. The account information may be charged as part of a bill sent to the user, or for royalty payments to the copyright owner.

A photo album typically contains two kinds of photographs: first “own” photographs provided by the user of client computer 10 and second “general” photographs, which are typically professionally made photographs whose copyright is exploited. In a first embodiment both types of photographs are stored in storage devices 14a,b (typically in different directories). As will be understood, with “general” it is meant that in this case the server computer 14 preferably is arranged to permit different access privileges for these directories. Typically the system is arranged to support a plurality of different users. Server computer 14 preferably is arranged to permit users in general to use photographs from a directory that contains the “general” photographs, but to permit only a specific user to use photographs from a directory that contains “own” photographs of that specific user. In this embodiment server computer sends identifiers of photographs of both types to client computer and receives back identifiers of both types of photograph to control printing. In another embodiment photographs of the first “own” type are stored on client computer 10 and selected photographs are transmitted with the editing result to control printing. Typically the system has an interface to enter general photographs into the directories from the server computer, whereas own photographs are entered into the server computer from client computers.

Although the invention has been described using a server system with a single server computer 14, it must be understood that more complicated server systems may be used. For example, different server computers (an editing server computer and a printing server computer) at mutually remote locations may be used for providing photographs and identifiers to client computer 10 and for receiving and executing print commands. In this case, the editing server computer needs to store only the low quality versions of the photographs and the printing server computer needs to store only the high quality versions. Alternatively, the printing server computer may send the identifiers to the editing server (or a further, storage server) to request transmission of the high quality version of the identified photographs. This does not compromise copyright if the printing server computer can be trusted. Typically the client computer and the parts of the server system are remote from one another, in that they run on physically separate computers, typically located in different buildings and connected via communication network 12.

Although an embodiment has been described wherein server computer 14 sends the identifiers, it must be understood that alternatively client computer may assign identifiers to photographs and send these identifiers to server computer 14. In this case server computer 14 associates these identifiers with the photographs for a particular user and uses the associated identifiers to retrieve the high quality versions in response to a printing command from the user.

Furthermore it will be understood that the identifiers need not be transmitted together with the low quality version, as long as a one to one association between photographs and identifiers is realized. For example, server computer 14 may first transmit a menu of photograph descriptions to menu computer, with identifiers and next supply the low quality versions in response to menu selections from client computer 10, so that client computer can derive from the menu which identifier should be used.

As has been described, the system preferably provides for a plurality of template pages of the photo album, each defining the positions of a set of locations for placing photographs on the page. Of course, alternatively, a user may specify the positions him- or herself at client computer 10, in the form of coordinates for example, and transmit information about the selected positions to server system 14 for use during printing. However, the use of templates has the advantage that layout errors are prevented. It has been found that free position selection leads to disturbing inaccuracies in the printed result. By defining predetermined positions for photographs in a template, the user selecting only templates, these inaccuracies can be avoided. Preferably, client computer 10 only sends information that identifies the template selection to server computer 14, without position information, server computer retrieving the position information for the identified template from locally stored template information. But of course, at the expense of more bandwidth use, positions from the template may be transmitted by client computer 10 instead.

In addition the user may enter text to be printed on the pages. Text positions are preferably defined by the templates, but may alternatively be user defined. Client computer 10 sends text data that has been entered to server system which prints the text at specified positions.

In an embodiment client computer 10 permits the user to select transformations of one or more of the photographs during editing (e.g. in first step 21), including for example one or more of selection of a window in a photograph for selectively placing only the part of the photograph that is in the window in the photo album, rotation, geometric distortion, adaptation of brightness, contrast, color saturation, gamma etc. In this case, client computer 10 records the transformations selected by the user and displays the result of applying the selected transformations to the user. When a print command is issued client computer 10 transmits information indicative of the selection of transformations to server system 14. Server system 14 then applies the selected transformations to the high quality photograph data that is stored locally in server system 14 and uses the transformed result for printing the photo album. It will be appreciated that in a simple form of the system such a transformation capability may be omitted, the photographs printed placed as is on the pages of the photo album.

Preferably, the client computer sends the template selection information and the transformation commands are sent to the server system together with the printing command. However, without deviating from the invention this information may also be sent separately, for example each time when a user selects a transformation or a template. In this case the server system accumulates a final set of template and transformation selections. Usually the transformations require processing at the server system, which need only be executed just before printing, not necessarily at the time when the user enters the commands; representations of transformed images for some transformations may even be cached at server system 14.

It will be understood that preferably the invention is implemented using suitably programmed computers, using programs stored on a disk or the like. However, without deviating from the invention dedicated client computers or server systems may be used. Thus for example, a dedicated photo album editing device with a screen and editing hardware may be provided.

1. A method of editing and printing a photo album, the method comprising:
storing low quality and high quality digital representations of photographs in a server system;
sending the low quality digital representations to a client computer remote from the server system in association with respective identifiers of the photographs;
editing an electronic representation of pages of the photo album at the client computer, using an interactive display with the low quality digital representations of interactively selected photographs;
sending an editing result of said editing from the client computer to the server system, including identifiers of the selected photographs;
retrieving, in the server system, the stored high quality digital representation of the selected photographs identified by the identifiers in the editing result;
printing the pages of the photo album in the server system using the retrieved high quality digital representations.

2. A method of editing and printing according to claim 1, wherein said editing comprises:
receiving selection commands for selection positions where the selected photographs must be printed on a page of the photo album;
sending information indicative of the selected positions from the client computer to the server system; and
wherein said printing including positioning the selected photographs according to said information.

3. A method of editing and printing according to claim 2, further comprising;
providing a plurality of available album page templates, each of the templates defining a plurality of locations for photographs at predefined positions for a page of the photo album;
receiving a selection of a particular template from the user; and
receiving commands from the user to select the positions of the selected photographs by associating the selected photographs with respective ones of positions from the particular template.

4. A method of editing and printing according to claim 3, wherein the information indicative of the selected positions includes an identification of the particular template, and wherein the server system stores information about the available templates and retrieves the position information for printing from the stored information.

5. A method of editing and printing according to claim 4, further comprising:
receiving a user selection of a transformation to be applied to a photograph;
displaying a transformation result of the low quality version at said client computer;
transmitting information indicative of the selected transformation to the server system; and
adapting the high quality version according to the selected transformation before printing.

6. A method of editing and printing according to claim 5, wherein the client computer provides for selection of the transformation from at least one of:
selection of a window in a photograph for selectively placing only the part of the photograph that is in the window in the photo album,
rotation, geometric distortion,
adaptation of brightness,
adaptation of contrast,
adaptation of color saturation and
adaptation of gamma.

7. A method of editing and printing according to claim 1, further comprising:
receiving text data in combination with a position specification at the client computer;
sending the text data to the server computer; and
printing text controlled by the text data on a page of the photo album at a position controlled by the position specification.

8. A photo album printing system, comprising:
a communication network;
a client computer coupled to the communication network and arranged to enable a user to interactively edit an electronic representation of pages of a photo album, the pages containing interactively selected photographs, each associated with a respective identifier; and
a server system coupled to the network, the server system comprising a photo printer and electronic storage space wherein digital representations of low quality and high quality versions of photographs are stored, the server system being arranged to transmit the low quality versions to the client computer in association with the respective identifiers, for display during editing, the client computer being arranged to transmit a electronic edit result representing the pages of the photo album to the server system, including the identifiers of the selected photographs in the resulting electronic representation, the server system being arranged to retrieve the high quality versions of the photographs from the storage space using the identifiers included with the edit result and to print the pages with the photo printer under control of the retrieved high quality versions of the photographs.

9. A photo album printing system according to claim 8, wherein the client computer is arranged to provide for user selection of a photo album page template from at least a plurality of page templates, wherein each of the templates defines a plurality of locations for photographs at predefined positions, the client computer enables the user to select a particular template from the templates, and to assign selected photographs to respective ones of the locations in the particular template, and the client computer transmits information identifying the selected template or the positions in the template to the server computer for use in printing.

10. A photo album printing system, wherein the client computer is arranged to provide for user selection of a transformation to be applied to a photograph, to display a transformation result of the low quality version and to transmit information indicative of the selected transformation to the server system, the server system being arranged to apply the transformation to the high quality version before printing.

11. A client computer programmed for editing a photo album, the client computer comprising:
a user command input device,
a processor,
a display screen and a connection for connecting to a server system, and
wherein the client computer is programmed to:
receive low quality digital representations of photographs from a remote server system in association with respective identifiers of the photographs;
receive editing commands from the user command input device, to select selected photographs for display on pages of a photo album;
display the edited pages;
send an editing result of said editing from the client computer to the server system, including identifiers of the selected photographs.

12. A client computer according to claim 11, further programmed to:
provide a plurality of available album page templates, wherein each of the templates defines a plurality of locations for photographs at predefined positions for a page of the photo album;
receive a selection of a particular template from the user; and
receive commands from the user to select the positions of the selected photographs by associating the selected photographs with respective ones of positions from the particular template.

13. A client computer according to claim 12, wherein the client computer is programmed to send an identification of the particular template to a server system for use in printing.

14. A client computer according to claim 11, further programmed to:
receive a user selection of a transformation to be applied to a photograph;
display a transformation result of the low quality version at said client computer; and
transmit information indicative of the selected transformation to the server system.

15. A server system for printing photo albums, the server system comprising:
a connection for connecting to one or more remote client computers,
a processor,
a storage apparatus storing low and high quality representations of respective photographs, wherein the server system is programmed to:
send the low quality digital representations to a client computer remote from the server system in association with respective identifiers of the photographs;
receive an editing result representing pages of a photo album, including identifiers of selected ones of the photographs;
retrieve the stored high quality digital representation of the selected photographs identified by the identifiers in the editing result; and
print the pages of the photo album in the server system using the retrieved high quality digital representations.

16. A server system according to claim 15, further programmed to receive information indicative of the selected positions on the pages of the photo album from the client computer; and print the pages with the selected photographs positioned according to said information.

17. A server system according to claim 16, which stores a plurality of page templates with each position information of a plurality of photo positions on a page, the server system being programmed to:
receive information indicative of a selected template from the client computer;
retrieve the position information from the selected template; and
print the selected photographs at positions controlled by the retrieved position information from the selected template.

18. A server system according to claim 15, further programmed to receive information indicative of a selected transformation from the client computer; and adapt or select the high quality version according to the selected transformation before printing.

19. A computer program product comprising instructions for programming a PC, including a user command input device, a processor, a display screen and a connection for connecting to a server system, to operate as a client computer, the computer program product facilitating performing the steps of:
receiving low quality digital representations of photographs from a remote server system in association with respective identifiers of the photographs;
receiving editing commands from the user command input device, to select selected photographs for display on pages of a photo album;
displaying the edited pages; and
sending an editing result of said editing from the client computer to the server system, including identifiers of the selected photo graphs.

20. A computer program product comprising instructions for programming a computer, including a a connection for connecting to one or more remote client computers, a processor, a storage apparatus storing low and high quality representations of respective photographs, to operate as a server computer, the computer program product facilitating performing the steps of:
sending the low quality digital representations to a client computer remote from the server system in association with respective identifiers of the photographs;
receiving an editing result representing pages of a photo album, including identifiers of selected ones of the photographs;
retrieving the stored high quality digital representation of the selected photographs identified by the identifiers in the editing result; and
printing the pages of the photo album in the server system using the retrieved high quality digital representations.
